(19) United States
(12) Patent Application Publication
(10) Pub. No.: US 2026/0208550 A1
(43) Pub. Date: Jul. 23, 2026

(54) TEMPERATURE-CONTROL SYSTEM FOR A VEHICLE

(71) Applicant: Ford Global Technologies, LLC, Dearborn, MI (US)

(72) Inventors: Ingo Krolewski, Neuss (DE); Bernd Dienhart, Koeln (DE)

(73) Assignee: Ford Global Technologies, LLC, Dearborn, MI (US)

(21) Appl. No.: 19/411,425

(22) Filed: Dec. 8, 2025

(30) Foreign Application Priority Data
Jan. 21, 2025 (DE) 102025101999.1

(51) Int. Cl. B60H 1/00

(52) U.S. Cl. CPC B60H 1/00028; B60H 1/00392; B60H 2001/00078; B60H 2001/00114; B60H 2001/0015

(57) ABSTRACT

A temperature-control system for a vehicle comprises a fluid conductor unit designed for connection to a vehicle heat exchanger having a first fluid channel for a feed fluid flow and a second fluid channel for a return fluid flow. In order to enable efficient operation of a vehicle-internal heating circuit, the present disclosure provides for the first and second fluid channels to be formed in a coherent line body and to be fluidically separated by a separation region of the line body, wherein the second fluid channel at least partially surrounds the first fluid channel such that the second fluid channel is interposed between the first fluid channel and an outer face of the line body.

### CROSS-REFERENCE TO RELATED APPLICATION

This application claims foreign priority benefits under 35 U.S.C. § 119(a)-(d) to German Application No. 102025101999.1 filed Jan. 21, 2025, which is hereby incorporated by reference in its entirety.

### FIELD OF THE DISCLOSURE

The present disclosure generally relates to a temperature-control system for a vehicle, and more particularly relates to a fluid conductor unit having fluid channels coupled to a vehicle heat exchanger.

### BACKGROUND OF THE DISCLOSURE

Heat pump systems may be employed in electric vehicles to generate heat for the vehicle interior space. For vehicles having a greater length such as minibuses or buses, it may be desirable for the working fluid of the heat pump to be transported from a front heat exchanger, which exchanges heat with the ambient air, over a considerable distance to a rear heat exchanger, which exchanges heat with the vehicle interior space, which applies to both heating and cooling of the vehicle interior space. It may be desirable to provide for the efficient operation of a vehicle internal heating circuit that may connect with the vehicle heat exchanger.

### SUMMARY OF THE DISCLOSURE

According to a first aspect of the present disclosure, a temperature-control system for a vehicle has a fluid conductor unit designed for connection to a vehicle heat exchanger with a first fluid channel for a feed fluid flow and a second fluid channel for a return fluid flow. The first and second fluid channels are formed in a coherent line body and fluidically separated by a separation region of the line body. The second fluid channel at least partially surrounds the first fluid channel such that the second fluid channel is interposed between the first fluid channel and an outer face of the line body.

Embodiments of the first aspect of the present disclosure can include any one or a combination of the following features:
the vehicle heat exchanger is designed for temperature control of a vehicle region,
wherein an inlet of the vehicle heat exchanger is connected to the first fluid channel and an outlet of the vehicle heat exchanger is connected to the second fluid channel;
at least one of the first and second fluid channels has a plurality of sub-channels which are separated at least in certain portions by at least one channel support structure;
the first fluid channel and the second fluid channel are each delimited in certain regions toward the outer face by a common outer wall which is adjoined in certain regions by one of the fluid channels;
the second fluid channel at least predominantly surrounds the first fluid channel, with the result that, in relation to a cross-section perpendicular to a course direction of the first fluid channel and a corresponding center of an area of the first fluid channel, the second fluid channel extends over an angle range of in total at least 270° around the center of the area;
the line body has a channel body which is manufactured in one piece from a fluid-tight wall material and within which the first fluid channel and the second fluid channel are formed;
the separation region has an intermediate insulation region which is designed to minimize heat transfer between the fluid channels and the average thermal conductivity of which is lower than that of the wall material;
interposed between the second fluid channel and the outer face is an outer insulation region which is designed to minimize heat transfer between the second fluid channel and the surroundings of the line body and the average thermal conductivity of which is preferably lower than that of the wall material;
at least one of the intermediate and outer insulation regions has at least one aperture, which has an at least partial vacuum;
the separation region has an inner partition delimiting the first fluid channel and an outer partition which is spaced apart from said inner partition and delimits the second fluid channel; and
the partitions are connected to one another by partition support structures.

According to a second aspect of the present disclosure, a fluid conductor unit designed for connection to a vehicle heat exchanger for a temperature-control system for a vehicle has a coherent line body, a first fluid channel formed in the coherent line body for a feed fluid flow, and a second fluid channel formed in the coherent line body for a return fluid flow. The first and second fluid channels are fluidically separated by a separation region of the line body. The second fluid channel at least partially surrounds the first fluid channel such that the second fluid channel is interposed between the first fluid channel and an outer face of the line body.

Embodiments of the second aspect of the present disclosure can include any one or a combination of the following features:
the vehicle heat exchanger is designed for temperature control of a vehicle region,
wherein an inlet of the vehicle heat exchanger is connected to the first fluid channel and an outlet of the vehicle heat exchanger is connected to the second fluid channel;
at least one of the first and second fluid channels has a plurality of sub-channels which are separated at least in certain portions by at least one channel support structure;
the first fluid channel and the second fluid channel are each delimited in certain regions toward the outer face by a common outer wall which is adjoined in certain regions by one of the fluid channels;
the second fluid channel at least predominantly surrounds the first fluid channel, with the result that, in relation to a cross-section perpendicular to a course direction of the first fluid channel and a corresponding center of an area of the first fluid channel, the second fluid channel extends over an angle range of in total at least 270° around the center of the area;
the line body has a channel body which is manufactured in one piece from a fluid-tight wall material and within which the first fluid channel and the second fluid channel are formed;
the separation region has an intermediate insulation region which is designed to minimize heat transfer between the fluid channels and the average thermal conductivity of which is lower than that of the wall material; and
interposed between the second fluid channel and the outer face is an outer insulation region which is designed to minimize heat transfer between the second fluid channel and the surroundings of the line body and the average thermal conductivity of which is preferably lower than that of the wall material.

According to a third aspect of the present disclosure, a vehicle has a vehicle heat exchanger designed for temperature control of a vehicle region with an inlet and an outlet and a fluid conductor unit. The fluid conductor unit has a coherent line body, a first fluid channel formed in the coherent line body for a feed fluid flow, and a second fluid channel formed in the coherent line body for a return fluid flow. The first and second fluid channels are fluidically separated by a separation region of the line body. The second fluid channel at least partially surrounds the first fluid channel such that the second fluid channel is interposed between the first fluid channel and an outer face of the line body.

Embodiments of the second aspect of the present disclosure can include any one or a combination of the following features:
the inlet of the vehicle heat exchanger is connected to the first fluid flow channel,
and the outlet of the vehicle heat exchanger is connected to the second fluid flow channel; and
the vehicle is an electric vehicle.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic side illustration of an electric vehicle having a temperature-control system according to the disclosure;

FIG. 2 is a perspective partial sectional illustration of one embodiment of a line body for the temperature-control system shown in FIG. 1;

FIG. 3 is a sectional illustration of the line body shown in FIG. 2;

FIG. 4 is a sectional illustration of another embodiment of a line body;

FIG. 5 is a sectional illustration of a further embodiment of a line body;

FIG. 6 is a sectional illustration of a further embodiment of a line body;

FIG. 7 is a sectional illustration of a further embodiment of a line body;

FIG. 8 is a sectional illustration of a further embodiment of a line body; and

FIG. 9 is a sectional illustration of yet a further embodiment of a line body.

### DETAILED DESCRIPTION OF PREFERRED EMBODIMENTS

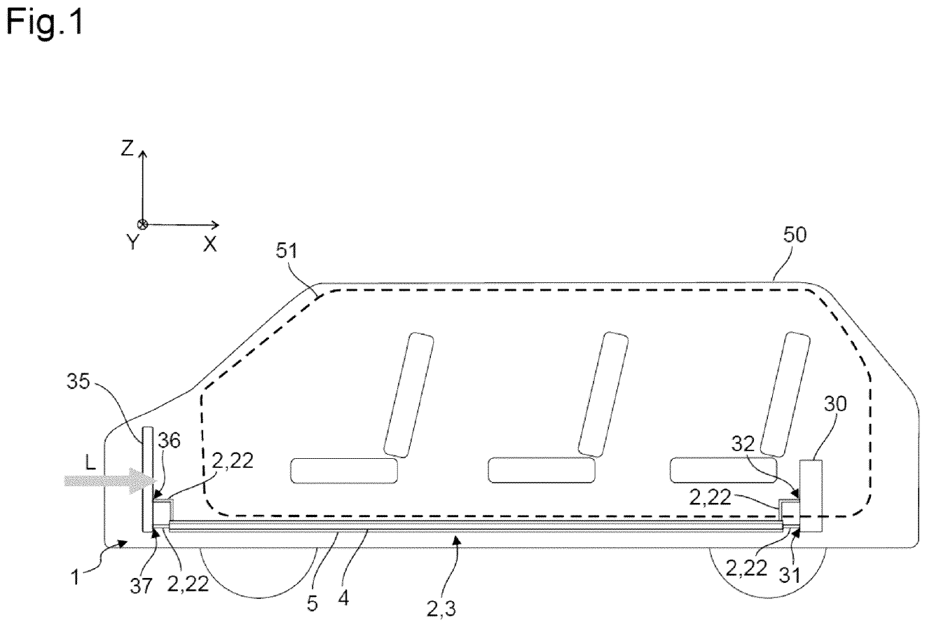

FIG. 1 shows a motor vehicle 50, for example a battery-powered electric vehicle (BEV), comprising a temperature-control system 1 according to the disclosure. The figure depicts a longitudinal axis X, a transverse axis Y and a vertical axis Z of the motor vehicle 50. An interior space 51 is schematically illustrated, which can also be referred to as passenger compartment. The temperature-control system 1 is used for temperature control of a vehicle region, in this case for temperature control of the interior space 51. The interior space 51 is assigned a vehicle heat exchanger 30, which is arranged at the rear with respect to the longitudinal axis X. Furthermore, the temperature-control system 1 has a front ambient heat exchanger 35, through which an air flow L passes. This air flow L may be generated by a driving movement of the motor vehicle 50 and/or by the action of a fan unit (not illustrated). The two heat exchangers 30, 35 form parts of a fluid circuit that functions according to the principle of a heat pump. They are connected by a fluid conductor unit 2, which has a line body 3 extending along the longitudinal axis X.

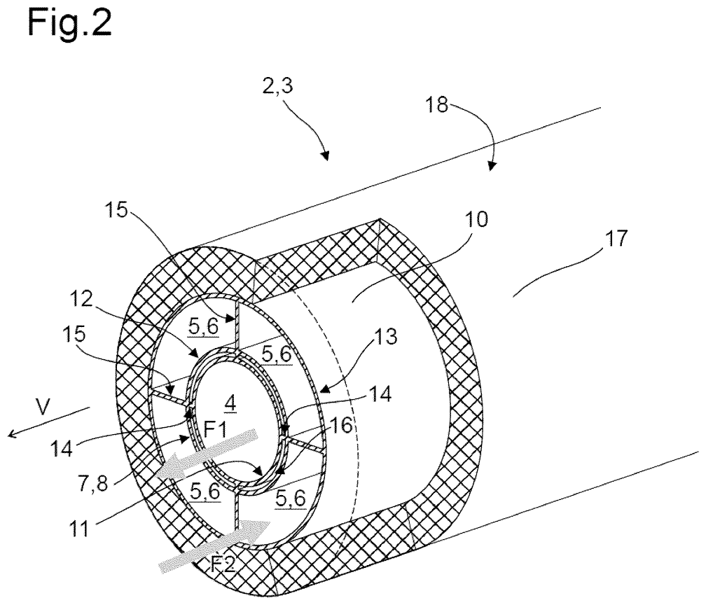

Formed within the line body 3 are a first fluid channel 4 and a second fluid channel 5. The first fluid channel 4 is connected to an inlet 31 of the vehicle heat exchanger 30 and to an outlet 37 of the ambient heat exchanger 35 via connecting lines 22. The second fluid channel 5 is connected to an outlet 32 of the vehicle heat exchanger 30 and to an inlet 36 of the ambient heat exchanger 35 via connecting lines 22. During operation, a feed fluid flow F1 illustrated in FIG. 2 is conducted through the first fluid channel 4 to the vehicle heat exchanger 30 and a return fluid flow F2 is conducted to the ambient heat exchanger 35. If the vehicle heat exchanger 30 is provided for cooling the interior space 50, it can be operated as an evaporator, with an expansion valve (not illustrated here) upstream thereof, while the ambient heat exchanger 35 is operated as a condenser, with a compressor (also not illustrated) upstream thereof. If the vehicle heat exchanger 30 is intended to be used for heating the interior space 50, it is operated as a condenser with an associated compressor and the ambient heat exchanger as an evaporator with an associated expansion valve.

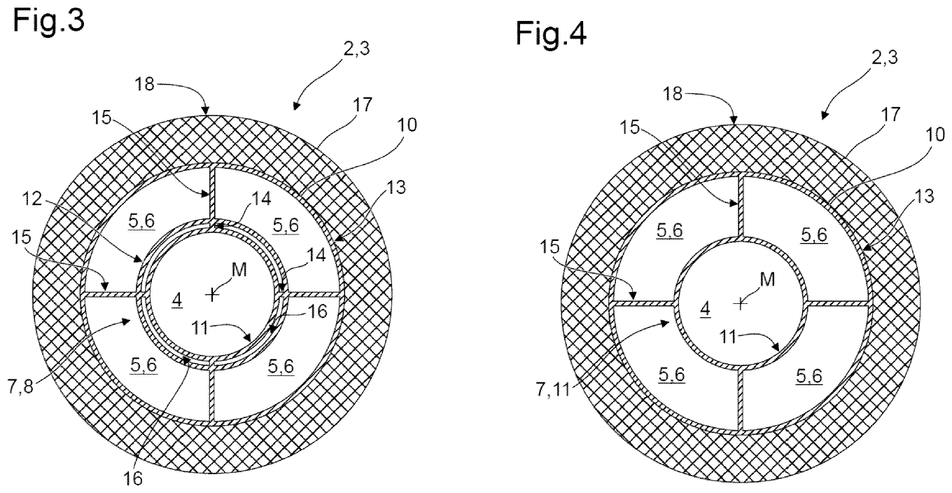

FIG. 2 shows a perspective partial sectional illustration of one embodiment of the line body 3, while FIG. 3 shows a sectional illustration of another embodiment whose section plane runs perpendicularly to a course direction V of the first fluid channel 4. The line body 3 has a channel body 10 which is manufactured in one piece as an extrusion profile and within which both fluid channels 4, 5 are defined. The channel body 10 has a fluid-tight wall material, for example aluminum. The first fluid channel 4 has a circular cross-section and is delimited by an inner partition 11. The inner partition 11 is connected to an outer partition 12 by four partition support structures 14. Both partitions 11, 12 have circular cross-sections and are spaced apart from one another so as to form four apertures 16. The apertures 16 can be filled with gas, for example air, wherein they preferably have at least a partial vacuum. They belong to a separation region 7 which forms an intermediate insulation region 8. The outside of the separation region 7 is adjoined by the second fluid channel 5, which is outwardly delimited by a first outer wall 13 which also has a circular cross-section. The first outer wall 13 is connected to the outer partition 12 by four channel support structures 15 which divide the second fluid channel 5 into four sub-channels 6. In turn, the outside of the first outer wall 13 is adjoined by an outer insulation region 17, which may include foamed material, for example, polymer foam or metal foam. The outer insulation region 17 forms an outer face 18 of the line body 3.

During the operation of the temperature-control system 1, the temperature of the feed fluid flow F1 typically differs significantly from an ambient temperature. By contrast, the temperature of the return fluid flow F2 lies between that of the feed fluid flow F1 and the ambient temperature. Direct thermal contact between the feed fluid flow F1 and the surroundings generally is not possible due to the construction of the line body 3. Overall, heat transfer between the feed fluid flow F1 and the surroundings is minimized by various factors. The first fluid channel 4 is thermally insulated in relation to the second fluid channel 5 by the intermediate insulation region 8. Furthermore, the comparatively low temperature difference between the two fluid channels 4, 5 ensures a low heat flow. The second fluid channel 5 thus forms insulation around the first fluid channel 4 which it completely surrounds - apart from the channel support structures 15. In relation to a center M of the cross-sectional area of the first fluid channel 4 illustrated in FIG. 3, the second fluid channel 5 extends in total over an angle range of approx. 350° around the first fluid channel 4. Heat transfer between the second fluid channel 5 and the surroundings is minimized by the presence of the outer insulation region 17. Each of the insulation regions 8, 17 may have an average thermal conductivity of less than 0.1 Wm−1K−1, preferably of less than 0.05 Wm−1K−1, more preferably of 0.01 Wm−1K−1. In any case, this lies significantly below a thermal conductivity of the wall material.

FIG. 4 shows a further embodiment of a line body 3 which largely corresponds to the embodiment according to FIGS. 2 and 3 and is not explained again in this respect. This embodiment is simplified insofar as the separation region 7 has only one partition 11. It is therefore not formed in the proper sense as an insulation region. However, the heat exchange between the two fluid channels 4, 5 is still comparatively low due to the moderate temperature difference.

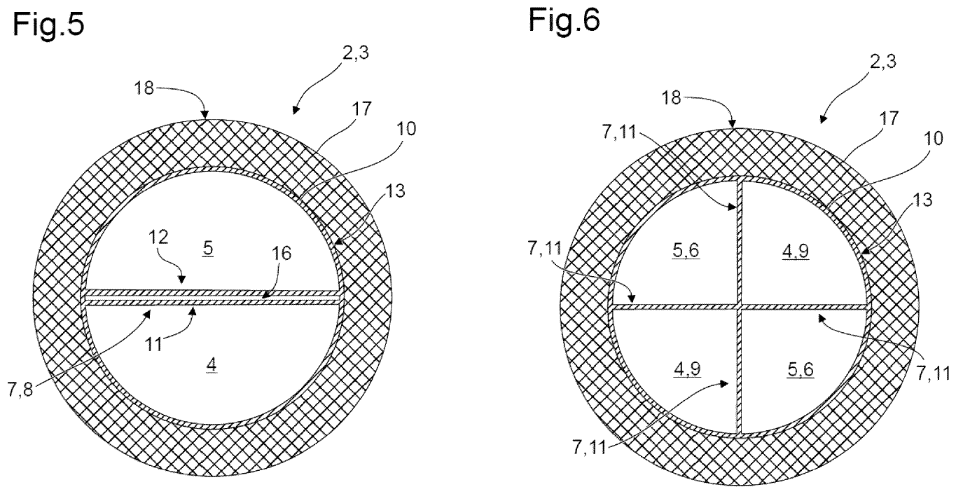

FIG. 5 shows a further embodiment of a line body 3 which again largely corresponds to the embodiment according to FIGS. 2 and 3. In this embodiment, however, both fluid channels 4, 5 have an approximately semicircular cross-section and are delimited toward the outer face 18 by a common outer wall 13. The outer wall 13 is adjoined by the first fluid channel 4 in a lower region with respect to FIG. 5 and by the second fluid channel 5 in an upper region with respect to FIG. 5. The fluid channels are separated by a separation region 7 with two partitions 11, 12 which extend straight between opposite sides of the outer wall 13. An aperture 16 is in turn formed between the partitions 11, 12, as a result of which the separation region 7 forms an insulation region 8. Both partitions 11 can be formed in one piece with the outer wall 13. Alternatively, they may also be manufactured separately and subsequently connected to the outer wall 13.

FIG. 6 shows a further embodiment of a line body 3 in which again both fluid channels 4, 5 adjoin a common outer wall 13. However, in this embodiment, the first fluid channel 4 has two sub-channels 9, each having a quarter-circular cross-section. The sub-channels 9 are separated by partitions 11 from two sub-channels 6 of the second fluid channel 5, which also have quarter-circular cross-sections. The sub-channels 6, 9 of the two fluid channels 4, 5 are thus arranged so as to alternate with one another and alternately adjoin the outer wall 13. The partitions 11 running in the form of a cross can be formed in one piece with the outer wall 13 or alternatively the partitions 11 can be prefabricated separately and subsequently connected to the outer wall 13. Both in this embodiment and in that in FIG. 5, both fluid channels 4, 5 have an identical cross-section, resulting in equal pressure losses in both fluid channels 4, 5.

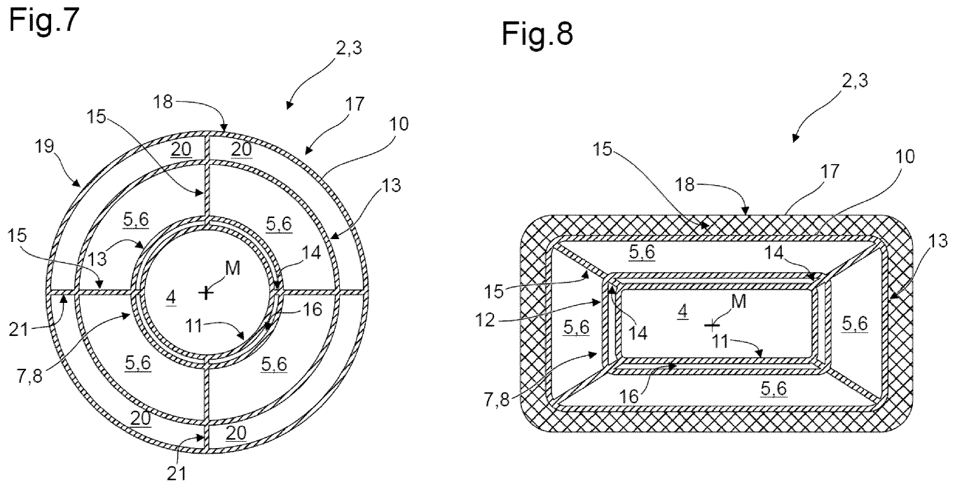

FIG. 7 shows a further embodiment of a line body 3 which again largely corresponds to the embodiment according to FIGS. 2 and 3. In this embodiment, however, the outer insulation region 17 is not formed by a foamed material, but rather has, similarly to the intermediate insulation region 8, two concentrically arranged walls 13, 19 which are connected to one another by outer support structures 21. Between them, a total of four apertures 20 are formed, which can have at least a partial vacuum. It is advantageous in this embodiment that the line body 2 has only the channel body 10 which is manufactured in one piece.

FIG. 8 shows a further embodiment, the basic construction of which resembles the embodiment according to FIGS. 2 and 3. In this embodiment, however, there is no circular symmetry, but rather the cross-section of the line body 2 is approximately rectangular. The same applies to the two partitions 11, 12 and to the outer wall 13. The rectangular geometry means, in comparison to a circular symmetry as in the embodiments according to FIGS. 2 to 7, an enlarged surface in relation to the volume, as a result of which the heat transfer between the fluid channels 4, 5 and between the second fluid channel 5 and the surroundings is increased. On the other hand, the geometry illustrated can be advantageous in terms of the installation space required.

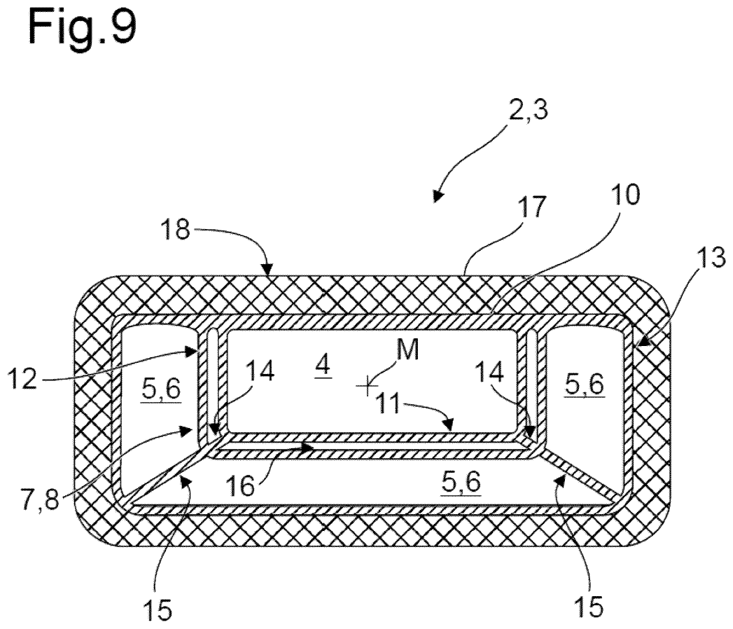

FIG. 9 shows a further embodiment of a line body 3 which resembles the embodiment according to FIG. 8. In this embodiment, however, the second fluid channel 5 has only three sub-channels 6 and also extends by significantly less than 350° around the first fluid channel 4. That is to say it does not approximately completely surround the first fluid channel 4. In this embodiment, it could be provided that the upper side of the line body 3 in FIG. 9, said upper side missing the second fluid channel 5, does not require as effective insulation as the other sides due to the installation position. Overall, the first fluid channel 4 is still shielded comparatively well from the surroundings by the second fluid channel 5 that partially surrounds the first fluid channel 4. This is supported in the example shown in that the outer insulation region 17 surrounds the channel body 10 on all sides.

The disclosure provides a temperature-control system for a vehicle. The temperature-control system is normally provided for motor vehicles such as buses, heavy goods vehicles or passenger cars, but could conceivably also be used for example for rail vehicles or watercraft. In particular, the temperature-control system may be provided for an electric vehicle, the term “electric vehicle” here denoting a vehicle which has at least one electric motor that serves for driving the vehicle. In particular, the vehicle may be a purely electrically powered vehicle, but this does not rule out use of the invention in hybrid vehicles. The term “temperature-control system” generally means that at least some components of the temperature-control system are at least indirectly used for controlling the temperature of components of the electric vehicle. “Temperature-control” in this context refers to the targeted influencing of a temperature, in particular in order to keep this temperature within a specified range or to bring it into such a range. It is also possible for components that are at least not directly used for temperature control to be regarded as part of the temperature-control system. This refers, inter alia, to components that control the actual “active” components or support them in their function.

The temperature-control system has a fluid conductor unit designed for connection to a vehicle heat exchanger. This means that, in the installed state within the vehicle, the fluid conductor unit is connected to the vehicle heat exchanger either directly or indirectly via at least one interposed element. It is used to lead a fluid or working fluid to the vehicle heat exchanger and to discharge it therefrom. Accordingly, it has two fluid channels. A first fluid channel is provided for a feed fluid flow. The feed fluid flow is a flow of working fluid that is provided during operation and leads to the vehicle heat exchanger. A second fluid channel is provided for a return fluid flow, which is a flow of working fluid that is provided during operation and continues on from the vehicle heat exchanger. In this respect, the return fluid flow can be described as inverse or opposite to the feed fluid flow. In the installed state, the mentioned fluid channels form parts of a fluid circuit, which can preferably be used according to the principle of a heat pump to heat or cool a vehicle interior space or another vehicle component. However, the present disclosure is not restricted to the principle of a heat pump. The working fluid can be present within the fluid channels in particular in liquid form, but it could also be at least partially gaseous. Each of the fluid channels can have a continuous cross-section. However, it would also be conceivable for at least one of the fluid channels to have a plurality of sub-channels that are adjacent to one another but separated from one another at least in certain portions.

According to the present disclosure, the fluid channels are formed in a coherent line body and fluidically separated by a separation region of the line body. The line body is of coherent design, i.e. it is either formed in one piece or includes a plurality of interconnected elements. The fluid channels are formed within the line body, i.e. the line body defines the fluid channels and forms a delimitation of the respective fluid channel. The fluid channels are separated from one another by a region of the line body, which is referred to here and below as the separation region. The separation region is interposed between the two fluid channels. It fluidically separates the fluid channels, i.e. no fluid can pass through the separation region from one fluid channel to the other. In principle, however, heat can be exchanged through the separation region.

The second fluid channel at least partially surrounds the first fluid channel in such a way that it is interposed between the first fluid channel and an outer face of the line body. The outer face of the line body is the face that outwardly delimits it, that is to say delineates it from the surroundings. Via this outer face, the line body exchanges heat with the surroundings, i.e. a heat flow can flow through the outer face. As is known, the strength of the heat flow is dependent on the temperature difference between the surroundings and that part of the line body which adjoins the outer face. If the vehicle heat exchanger is intended to be operated for heating, the feed fluid flow has a higher temperature than the return fluid flow. If the vehicle heat exchanger is intended to be operated for cooling, the feed fluid flow has a lower temperature than the return fluid flow. In both cases, the temperature difference between the surroundings and the feed fluid flow is greater than between the surroundings and the return fluid flow. This is due to the fact that the latter is formed by fluid which at the vehicle heat exchanger has released a significant amount of heat in the case of heating or has absorbed a significant amount of heat in the case of cooling. It can thus be assumed that the temperature within the second fluid channel is closer to the ambient temperature than the temperature within the first fluid channel. Instead of saying that the second fluid channel at least partially surrounds the first fluid channel, it can also be said that the second fluid channel at least partially insulates the first fluid channel in relation to the outer face.

Since the second fluid channel at least partially surrounds the first fluid channel, that is to say is interposed at least in certain regions between the first fluid channel and the surroundings, it forms an insulating layer of medium temperature which lies between that of the first fluid channel and that of the surroundings. Due to the lower temperature differences alone, a possible heat flow (more precisely, a heat flux density) between the first fluid channel and the second fluid channel is lower than a heat flow between the first fluid channel and the surroundings if the second fluid channel were not to be interposed. Even if heat is exchanged between the fluid channels, this is an internal heat exchange within the fluid circuit, which is less difficult than a heat exchange with the surroundings. Also due to lower temperature differences, a heat flow between the second fluid channel and the surroundings is lower than a heat flow between the first fluid channel and the surroundings would be. It is possible within the scope of the present disclosure that some regions of the first fluid channel are insulated in the described way by the second fluid channel, while other regions are not insulated in this way, because the second fluid channel only partially surrounds the first fluid channel. In connection with the present disclosure, the second fluid channel “surrounds” the first fluid channel partially even if it is arranged only on one side thereof, for example only above or below the first fluid channel with respect to a vehicle vertical axis or only to the left or right of the first fluid channel with respect to a vehicle transverse axis. However, even partial or regional insulation already leads to a reduction in heat loss to the surroundings and thus to an enhancement in efficiency. A decisive advantage is that the second fluid channel, which is necessary in any case, is used for the insulation of the first fluid channel. In contrast to conventional insulation, no additional installation space is thus required.

The temperature-control system may in particular comprise the above-mentioned vehicle heat exchanger. Preferably, the latter is designed for temperature control of a vehicle region, wherein an inlet of the vehicle heat exchanger is connected to the first fluid channel and an outlet of the vehicle heat exchanger is connected to the second fluid channel. The vehicle heat exchanger is designed for temperature control of the mentioned vehicle region, that is to say for heating and/or cooling. It can also be referred to more generally as first heat exchanger. The inlet is the connection of the vehicle heat exchanger via which fluid enters the vehicle heat exchanger in the operating state, whereas it exits the vehicle heat exchanger through the outlet. The connection of the first fluid channel to the inlet may be provided directly or indirectly, that is to say via a further fluid-conducting element. The same applies to the connection of the second fluid channel to the outlet. In the installed state, the vehicle heat exchanger is in at least indirect thermal contact with the vehicle region, as a result of which a heat exchange between the vehicle heat exchanger and the vehicle region is possible. In particular, the vehicle heat exchanger may be designed to release heat to air in the vehicle region or absorb heat from this air. The vehicle region may in particular be a vehicle interior space, that is to say a passenger compartment. In particular, the vehicle heat exchanger may be arranged at the rear within the vehicle, while the fluid conductor unit extends along the longitudinal axis of the vehicle over at least 50% or at least 70% of the total length of the vehicle.

A further heat exchanger may be arranged at the front, which can also be referred to as ambient heat exchanger if it is provided for heat exchange with the ambient air, or simply as second heat exchanger. The first fluid channel is connected to an outlet of the second heat exchanger or ambient heat exchanger and the second fluid channel is connected to an inlet of same. The temperature-control system may operate according to the principle of a heat pump. If cooling of the vehicle region is intended or desired, the second heat exchanger can be operated as a condenser in which the fluid is liquefied, releasing heat, while the vehicle heat exchanger is operated as an evaporator in which the fluid evaporates, absorbing heat. Accordingly, the first fluid channel may be connected to an expansion valve, while the second fluid channel is connected to a compressor. If heating of the vehicle region is intended or desired, the second heat exchanger can be operated as an evaporator and the vehicle heat exchanger as a condenser. However, it is not necessarily necessary for liquefaction and evaporation of the fluid to be provided or carried out, but rather the fluid can also absorb and release heat without changing its aggregate state.

According to one refinement, at least one of the fluid channels has a plurality of sub-channels which are separated at least in certain portions by at least one channel support structure. The term “support structure” should not be interpreted as restrictive, it merely indicates that the mentioned structure can contribute to the support or mechanical stabilization of the fluid channel. It may extend between two walls that delimit the fluid channel. This allows the at least one channel support structure to divide the fluid channel into sub-regions which cannot exchange any fluid with one another at least in certain portions. Each sub-channel conducts a part of the respective fluid flow, that is to say the feed fluid flow or the return fluid flow. If the channel support structure extends only over a limited part of the fluid channel, the fluid flow branches at the beginning of the channel support structure into partial flows and/or partial flows merge at the end of the channel support structure to form a single fluid flow. The walls delimiting the fluid channel and the at least one channel support structure may preferably be formed in one piece with one another. In particular, they may be formed by a channel body explained below.

According to one embodiment, the first fluid channel and the second fluid channel are each delimited in certain regions toward the outer face by a common outer wall which is adjoined in each case in certain regions by one of the fluid channels. The outer wall may at least partially form the outer face. In any case, it is a common outer wall of both fluid channels, i.e. it delimits both the first fluid channel and the second fluid channel in each case in certain regions. In a first region, it may delimit the first fluid channel, whereby the first fluid channel adjoins the outer wall in the first region. In a second region, the partition may delimit the second fluid channel, whereby the second fluid channel adjoins the outer wall in the second region. In the second region, the second fluid channel is interposed between the first fluid channel and the outer face and partially surrounds the first fluid channel within the meaning of the disclosure. The two fluid channels are jointly arranged within the outer wall and may be separated by at least one partition, which can also be formed as a channel support structure. It is also possible for both fluid channels to have a plurality of sub-channels which alternately adjoin the outer wall in certain regions. For example, the outer wall may be adjoined by sub-channels of the first fluid channel in a first and third region, and by sub-channels of the second fluid channel in a second and fourth region. Irrespective of whether or not the fluid channels have sub-channels, in this embodiment, in particular an identical or at least approximately identical cross-section of the two fluid channels can be realized, e.g. by both fluid channels having a semicircular cross-section and being delimited by an outer wall of circular cross-section. An at least approximately identical cross-section leads to approximately identical pressure losses in the two fluid channels during operation, which may be advantageous.

The second fluid channel can shield the first fluid channel from the surroundings all the better the more completely it surrounds it. On the one hand, embodiments are conceivable in which for different reasons, for example to reduce the installation space, significant regions of the first fluid channel are not surrounded by the second fluid channel. In particular, this may be the case in the above-mentioned embodiment in which both fluid channels adjoin a common outer wall. In many cases, however, it is preferable for the second fluid channel to at least predominantly surround the first fluid channel, with the result that, in relation to a cross-section perpendicular to a course direction of the first fluid channel and a corresponding center of the area of the first fluid channel, the second fluid channel extends over an angle range of in total at least 270°, at least 300° or at least 330° around the center of the area. The course direction of the first fluid channel may correspond to an axis of symmetry of same and/or to a general flow direction of the feed fluid flow. In general, the first fluid channel, as well as the line body as a whole, may be of curved and/or angled design in certain regions, such that it has a course direction that differs in a location-dependent manner. In this respect, the statement made here applies to at least one region of the line body. If a cross-section perpendicular to the course direction is considered, a center of the cross-sectional area of the first fluid channel can be determined. If the cross-sectional area has no point symmetry, the center of the area corresponds to the centroid. With respect to this center of the area, it is possible to clearly determine angles over which the second fluid channel extends. In the case of an extent over an angle range of 360°, the second fluid channel would completely surround the first fluid channel. For constructional reasons, in particular because an outer wall of the second fluid channel should be supported against an inner wall, an angle range of 360° possibly cannot be realized. However, an extent over a total of at least 270°, 300° or 330° is particularly effective, without this leading to significant disadvantages compared to a 360° extent. If the second fluid channel is interrupted by support structures as described, the total extent can result from the sum of multiple sub-regions, for example four sub-regions or sub-channels each with an extent of 80° could be provided in the case of an extent over 320°, a support structure with an extent of 10° being arranged between each of the four sub-regions or sub-channels.

The line body is coherent, but may consist of multiple sub-elements that have been prefabricated separately and subsequently connected to one another. Preferably, however, the line body has a channel body which is manufactured in one piece from a fluid-tight wall material and within which the first fluid channel and the second fluid channel are formed. In some embodiments, the channel body may be identical to the line body, while in other embodiments, the line body has further elements that are connected to the channel body, e.g. by a material bond. The channel body itself is manufactured in one piece, for example by primary forming. For example, it may be manufactured as an extrusion profile. In any case, both the first fluid channel and the second fluid channel are formed within the channel body. It can also be said that the channel body defines the first and second fluid channel. These thus form apertures within the channel body. The channel body includes a material which is referred to here as wall material since it forms the walls of the fluid channels. It is fluid-tight, i.e. it can be penetrated at most to a negligible extent, if at all, by the fluid to be absorbed in the operating state. For example, it may be a plastic, for example fiber-reinforced plastic, or a metal.

In general, the separation region is used to prevent fluid exchange between the first and second fluid channel. By contrast, depending on the embodiment, thermal insulation of the two fluid channels may be less important. Since, however, the feed fluid flow and the return fluid flow may possibly have significantly different temperatures, such thermal insulation is also advantageous. This is taken into account according to a preferred embodiment in that the separation region has an intermediate insulation region which is designed to minimize heat transfer between the fluid channels and the average thermal conductivity of which is preferably lower than that of the wall material. In some embodiments, the separation region may be formed as an intermediate insulation region, in other embodiments, the intermediate insulation region forms only a part of the separation region. In any case, the intermediate insulation region is interposed between the two fluid channels, which is why at least a proportion of a possible heat flow between the first and second fluid channel must pass through the intermediate insulation region. The heat transfer between the fluid channels can therefore be minimized by a suitable design of the intermediate insulation region. This is possible in particular due to a suitable, low thermal conductivity of the intermediate insulation region. Since the thermal conductivity is a specific property of a material and the intermediate insulation region may possibly comprise different materials, reference can rightly be made here to an average thermal conductivity. The average thermal conductivity can in particular correspond to an average value of the thermal conductivity over the entire volume of the intermediate insulation region. If, as described above, the fluid channels are formed within a one-piece channel body, the average thermal conductivity of the intermediate insulation region may preferably be lower than that of the wall material. This can for example be achieved by the intermediate insulation region being formed within cutouts of the channel body or by the intermediate insulation region being partially formed by the channel body but additionally having at least one region with lower thermal conductivity.

Although the second fluid channel completely or partially shields the first fluid channel from the surroundings, there may be a non-negligible exchange of heat between the second fluid channel and the surroundings. This can already be disadvantageous in its own right. In addition, it also indirectly influences the heat exchange between the first and second fluid channel, since the temperature of the return fluid flow approximates to the temperature of the surroundings. For these reasons, it is preferable that interposed between the second fluid channel and the outer face is an outer insulation region which is designed to minimize heat transfer between the second fluid channel and the surroundings of the line body and the average thermal conductivity of which is preferably lower than that of the wall material. In this case, the outer face may in particular also be formed entirely or partly as the surface of the outer insulation region. The outer insulation region is located outside the second fluid channel. In some embodiments, it may be formed outside the above-mentioned channel body, but it is also possible for the outer insulation region to be formed by a part of the channel body or within the channel body. In embodiments in which the second fluid channel only partially surrounds the first fluid channel, the outer insulation region may also extend into those regions in which the second fluid channel does not extend. In these regions in which the second fluid channel cannot shield the first fluid channel from the surroundings, the corresponding shielding can be achieved by the outer insulation region. In turn, the heat transfer between the second fluid channel and the surroundings can be achieved in particular by a low average thermal conductivity of the outer insulation region. This may advantageously be lower than the thermal conductivity of the wall material.

Advantageously, at least one of the insulation regions has an average thermal conductivity of less than 0.1 Wm−1K−1, preferably of less than 0.05 Wm−1K−1, more preferably of 0.01 Wm−1K−1. Such thermal conductivities lie below those of metals and plastics, provided they are solid. This means that even if the above-mentioned channel body includes plastic, an insulation region with a thermal conductivity below 0.1 Wm−1K−1 significantly enhances the insulation and reduces the heat transfer.

In order to minimize the heat exchange between the first fluid channel and the second fluid channel and/or the heat exchange between the second fluid channel and the surroundings, it is preferable for at least one of the fluid channels to have a cross-sectional area bounded in the form of a circular arc. “In the form of a circular arc” denotes a circle or part of a circle. The surface via which the corresponding fluid channel can exchange heat is minimized in relation to its volume by way of such a boundary.

With a solid body, the above-mentioned thermal conductivities can be achieved only with difficulty. Therefore, it is preferable for at least one of the insulation regions to have at least one aperture, which preferably has a vacuum or at least a partial vacuum. The aperture may be comparatively large and extend, for example, over 5% to 100% of the insulation region. For example, the insulation region could have a solid shell surrounding the aperture. Alternatively, a large number of apertures may be formed, the extent of which is, for example, less than 0.1% of the extent of the insulation region. In this case, the insulation region could consist of porous, in particular foamed material such as polystyrene foam, polyurethane foam or aluminum foam. In the case of foamed material, the apertures are typically filled with air. In the case of a larger aperture, it can either be filled with gas, e.g. air, under normal pressure, or it can have a reduced internal pressure. This means that there may be a vacuum or partial vacuum, a gas-tight shell being used to maintain it.

In particular, the separation region may have an inner partition delimiting the first fluid channel and an outer partition which is spaced apart from said inner partition and delimits the second fluid channel, wherein the partitions are connected to one another by partition support structures. The inner partition is arranged on the side of the first fluid channel and can in particular delimit it. Accordingly, the outer partition is arranged on the side of the second fluid channel and can in particular delimit it. The partitions are spaced apart and define at least one aperture between them. They are connected to one another by partition support structures. These partition support structures may divide the aperture into a plurality of apertures. The partitions and the partition support structures may preferably be formed in one piece with one another. In particular, they may be formed by the above-mentioned channel body.

It should be noted that the features and measures specified individually in the following description can be combined with one another in any desired technically meaningful way and disclose further refinements of the present disclosure. The description additionally characterizes and specifies the present disclosure, in particular in conjunction with the figures. The terms “first”, “second”, etc. used in this application serve only for the purpose of differentiation. In particular, their use is not intended to imply any sequence or priority of the objects specified in conjunction with these terms.

What is claimed is:

1. A temperature-control system for a vehicle, the temperature-control system comprising:
a fluid conductor unit designed for connection to a vehicle heat exchanger and having a first fluid channel for a feed fluid flow and a second fluid channel for a return fluid flow, wherein the first and second fluid channels are formed in a coherent line body and fluidically separated by a separation region of the line body, and wherein the second fluid channel at least partially surrounds the first fluid channel such that the second fluid channel is interposed between the first fluid channel and an outer face of the line body.

2. The temperature-control system according to claim 1, wherein the vehicle heat exchanger is designed for temperature control of a vehicle region, wherein an inlet of the vehicle heat exchanger is connected to the first fluid channel and an outlet of the vehicle heat exchanger is connected to the second fluid channel.

3. The temperature-control system according to claim 1, wherein at least one of the first and second fluid channels has a plurality of sub-channels which are separated at least in certain portions by at least one channel support structure.

4. The temperature-control system according to claim 1, wherein the first fluid channel and the second fluid channel are each delimited in certain regions toward the outer face by a common outer wall which is adjoined in certain regions by one of the fluid channels.

5. The temperature-control system according to claim 1, wherein the second fluid channel at least predominantly surrounds the first fluid channel, with the result that, in relation to a cross-section perpendicular to a course direction of the first fluid channel and a corresponding center of an area of the first fluid channel, the second fluid channel extends over an angle range of in total at least 270° around the center of the area.

6. The temperature-control system according to claim 1, wherein the line body has a channel body which is manufactured in one piece from a fluid-tight wall material and within which the first fluid channel and the second fluid channel are formed.

7. The temperature-control system according to claim 1, wherein the separation region has an intermediate insulation region which is designed to minimize heat transfer between the fluid channels and the average thermal conductivity of which is lower than that of the wall material.

8. The temperature-control system according to claim 7, wherein interposed between the second fluid channel and the outer face is an outer insulation region which is designed to minimize heat transfer between the second fluid channel and the surroundings of the line body and the average thermal conductivity of which is preferably lower than that of the wall material.

9. The temperature-control system according to claim 8, wherein at least one of the intermediate and outer insulation regions has at least one aperture, which has an at least partial vacuum.

10. The temperature-control system according to claim 1, wherein the separation region has an inner partition delimiting the first fluid channel and an outer partition which is spaced apart from said inner partition and delimits the second fluid channel, wherein the partitions are connected to one another by partition support structures.

11. A fluid conductor unit designed for connection to a vehicle heat exchanger for a temperature-control system for a vehicle, the fluid conductor unit comprising:
a coherent line body;
a first fluid channel formed in the coherent line body for a feed fluid flow; and
a second fluid channel formed in the coherent line body for a return fluid flow, wherein the first and second fluid channels are fluidically separated by a separation region of the line body, and wherein the second fluid channel at least partially surrounds the first fluid channel such that the second fluid channel is interposed between the first fluid channel and an outer face of the line body.

12. The fluid conductor unit according to claim 11, wherein the vehicle heat exchanger is designed for temperature control of a vehicle region, wherein an inlet of the vehicle heat exchanger is connected to the first fluid channel and an outlet of the vehicle heat exchanger is connected to the second fluid channel.

13. The fluid conductor unit according to claim 11, wherein at least one of the first and second fluid channels has a plurality of sub-channels which are separated at least in certain portions by at least one channel support structure.

14. The fluid conductor unit according to claim 11, wherein the first fluid channel and the second fluid channel are each delimited in certain regions toward the outer face by a common outer wall which is adjoined in certain regions by one of the fluid channels.

15. The fluid conductor unit according to claim 11, wherein the second fluid channel at least predominantly surrounds the first fluid channel, with the result that, in relation to a cross-section perpendicular to a course direction of the first fluid channel and a corresponding center of an area of the first fluid channel, the second fluid channel extends over an angle range of in total at least 270° around the center of the area.

16. The fluid conductor unit according to claim 11, wherein the line body has a channel body which is manufactured in one piece from a fluid-tight wall material and within which the first fluid channel and the second fluid channel are formed.

17. The fluid conductor unit according to claim 11, wherein the separation region has an intermediate insulation region which is designed to minimize heat transfer between the fluid channels and the average thermal conductivity of which is lower than that of the wall material, and wherein interposed between the second fluid channel and the outer face is an outer insulation region which is designed to minimize heat transfer between the second fluid channel and the surroundings of the line body and the average thermal conductivity of which is preferably lower than that of the wall material.

18. A vehicle comprising:
a vehicle heat exchanger designed for temperature control of a vehicle region and having an inlet and an outlet; and
a fluid conductor unit comprising:
a coherent line body;
a first fluid channel formed in the coherent line body for a feed fluid flow; and
a second fluid channel formed in the coherent line body for a return fluid flow, wherein the first and second fluid channels are fluidically separated by a separation region of the line body, and wherein the second fluid channel at least partially surrounds the first fluid channel such that the second fluid channel is interposed between the first fluid channel and an outer face of the line body.

19. The vehicle according to claim 18, wherein the inlet of the vehicle heat exchanger is connected to the first fluid flow channel, and the outlet of the vehicle heat exchanger is connected to the second fluid flow channel.

20. The vehicle according to claim 19, wherein the vehicle is an electric vehicle.
